(19) United States
(12) Patent Application Publication
(10) Pub. No.: US 2026/0336482 A1
(43) Pub. Date: Oct. 29, 2026

(54) VEHICLE SEAT

(71) Applicant: TOYOTA BOSHOKU KABUSHIKI KAISHA, Aichi (JP)

(72) Inventor: Takao YAMAGUCHI, Toyota-shi (JP)

(73) Assignee: TOYOTA BOSHOKU KABUSHIKI KAISHA, Aichi (JP)

(21) Appl. No.: 19/653,786

(22) Filed: Apr. 21, 2026

(30) Foreign Application Priority Data
Apr. 25, 2025 (JP) 2025-073199

(51) Int. Cl. B60N 2/12

(52) U.S. Cl. CPC B60N 2/12

(57) ABSTRACT

A vehicle seat is provided. The vehicle seat of the present disclosure is provided with a walk-in function that enables a seat body including a seatback and a seat cushion to slide forward in a state where the seatback is tilted forward at a predetermined angle, and a fold-down function that tilts the seatback forward beyond the predetermined angle. The vehicle seat includes, a slide mechanism; a recliner; a cam lever; a first link lever; a stopper; a spring; a second link lever; a first operation cable; and a second operation cable.

### CROSS-REFERENCE TO RELATED APPLICATIONS

This application claims the benefit of Japanese Patent Application No. 2025-073199 filed on Apr. 25, 2025 with the Japan Patent Office, the entire disclosure of which is incorporated herein by reference.

### BACKGROUND

The present disclosure relates to a vehicle seat.

A vehicle seat disclosed in Japanese Patent No. 6711143 (Patent Document 1) includes a fold-down function and a walk-in function. The fold-down function (also referred to as a large-fold function) is a function for tilting a seatback significantly forward beyond an angle mentioned below.

The walk-in function is a function for improving accessibility into and out of a vehicle and is a function that enables a seat body to slide forward in a state where a seatback is tilted forward at a predetermined angle (for example, 45 degrees).

### SUMMARY

As described above, the vehicle seat disclosed in Patent Document 1 is provided with mechanisms for achieving the walk-in function and the fold-down function. The present disclosure discloses a novel mechanism for achieving the walk-in function and/or the fold-down function, and an example of a vehicle seat provided with such a novel mechanism.

A vehicle seat provided with a walk-in function that enables a seat body including a seatback and a seat cushion to slide forward in a state where the seatback is tilted forward at a predetermined angle, and a fold-down function that tilts the seatback forward beyond the predetermined angle preferably includes, for example, at least one of the following elements.

Specifically, the elements are a slide mechanism configured to slidably support the seat body and configured to be switchable between a slidable state and a non-slidable state; a recliner configured to be switchable between a released state for allowing rotation of the seatback and a locked state for not allowing rotation of the seatback, the recliner being brought into the released state during execution of the walk-in function and the fold-down function; a cam lever configured to be rotationally displaced integrally with the seatback about a rotational center axis of the recliner; a first link lever having a contact portion contactable with the cam lever, the first link lever being configured to be rotationally displaced between a first position where the contact portion contacts the cam lever and a second position where the contact portion is incapable of contacting the cam lever, the first link lever being configured to be pushed by the cam lever to be rotationally displaced in a state where the cam lever and the contact portion are in contact with each other; a stopper configured to restrict maximum displacement of the first link lever by contacting the first link lever which has been displaced by being pushed by the cam lever; a spring configured to generate an elastic force to bring the first link lever to the first position; a second link lever configured to rotate about the rotational center axis common to the first link lever, the second link lever being configured to rotate in a direction identical to a direction of rotation of the first link lever in conjunction with the first link lever when rotating from the first position toward the second position; a first operation cable configured to be operated when executing the fold-down function and thereby rotating the second link lever from the first position toward the second position; and a second operation cable configured to be operated by the first link lever that is rotationally displaced by being pushed by the cam lever, the second operation cable being configured to place the slide mechanism in a slidable state.

According to such a configuration, in the vehicle seat, when the recliner is brought into the released state in a state where the first operation cable is not operated, the cam lever and the contact portion come into contact with each other, so that the first link lever is rotationally displaced in response to the rotational displacement of the cam lever.

When the first link lever is rotationally displaced, the second operation cable is operated by the first link lever, thereby bringing the slide mechanism into the slidable state.

When the recliner is brought into the released state in a state where the first operation cable is not operated, the walk-in function is executed. At this time, the maximum displacement of the first link lever is restricted by the stopper, so that the seatback is restricted from tilting forward beyond a predetermined angle.

In the vehicle seat, when the recliner is brought into the released state in a state where the first operation cable is operated, the second link lever rotates, so that the first link lever is rotationally displaced from the first position to the second position in conjunction with the rotation of the second link lever.

Accordingly, since the cam lever can rotate without coming into contact with the contact portion, the seatback tilts without being restricted by the stopper. Therefore, the seatback is allowed to tilt forward beyond the predetermined angle, so that the fold-down function is executed.

In the vehicle seat, the first link lever and the second link lever are disposed coaxially. Accordingly, in the vehicle seat, the walk-in function and the fold-down function can be achieved with a simpler structure as compared with Patent Document 1.

The vehicle seat may be configured as described below, for example.

That is, preferably, the vehicle seat includes a second spring directly or indirectly coupled to the first link lever and the second link lever, the second spring being configured to generate an elastic force that draws the first link lever toward the second link lever.

Accordingly, when the first operation cable is operated, the first link lever and the second link lever are rotationally displaced integrally with each other, so that the first link lever, that is, the contact portion, is rotationally displaced to the second position.

When the cam lever rotates in a state where the cam lever and the contact portion are in contact with each other, the second spring elastically deforms, whereby the first link lever can be rotationally displaced until the first link lever comes into contact with the stopper.

Preferably, the vehicle seat includes a third spring having a spiral shape and configured to generate an elastic force for tilting the seatback forward, the third spring being disposed on a side of the seat frame where the first link lever and the second link lever are disposed. Preferably, the first link lever and the second link lever are disposed below the third spring.

### BRIEF DESCRIPTION OF THE DRAWINGS

An example embodiment of the present disclosure will be described hereinafter with reference to the accompanying drawings, in which:

FIG. 1 is a view of a vehicle seat;

FIG. 2 is a view of the vehicle seat;

FIG. 3 is a view of a slide mechanism and a lock mechanism;

FIG. 4 is a view of operation levers and the like;

FIG. 5 is an exploded view of a walk-in execution mechanism;

FIG. 6 is a view of the walk-in execution mechanism;

FIG. 7 is a view of the walk-in execution mechanism;

FIG. 8 is a view of the walk-in execution mechanism;

FIG. 9 is a view of the walk-in execution mechanism;

FIG. 10 is a view of the walk-in execution mechanism;

FIG. 11 is a view of the walk-in execution mechanism; and

FIG. 12 is a view of the walk-in execution mechanism.

### DETAILED DESCRIPTION OF EXEMPLARY EMBODIMENTS

Following “embodiments of the invention” represent examples of embodiments that fall within the technical scope of the present disclosure. In other words, matters used to specify the invention or the like recited in the claims are not limited to any specific configuration, structure, or the like described in the following embodiments.

The present embodiments show examples of a seat (hereinafter referred to as vehicle seat) provided to be mounted to a vehicle such as a car. Arrows for indicating directions, oblique lines, or the like in each drawing are used to facilitate understanding of mutual relations between the drawings, the shape of members or portions, or the like.

The orientation of the vehicle seat is not limited to how the vehicle seat is oriented in each drawing. The directions in each drawing are provided to show the orientation of the vehicle seat of the present disclosure when it is assembled to a car.

With respect to at least a member or a portion explained with a reference numeral, at least one of such a member or a portion is disposed unless it is described using a term such as “only one of”. In other words, unless it is described using a term such as “only one of”, two or more of such a member or a portion may be disposed. The vehicle seat of the present disclosure includes at least one of elements, such as at least a member or a portion explained with a reference numeral, or a structural component shown in the drawings.

### First Embodiment

### 1. Outline of Vehicle Seat

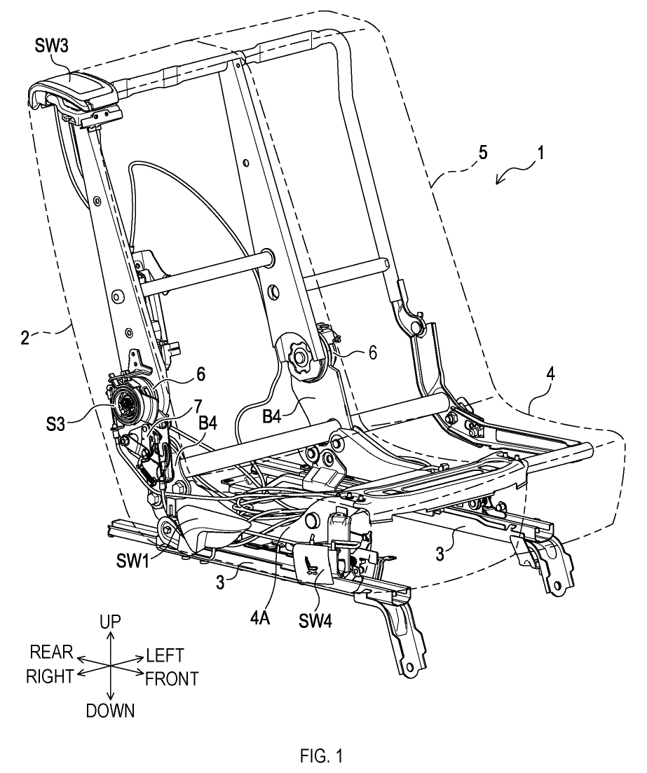

A vehicle seat according to the present embodiment is a vehicle seat applied to a second-row seat of so-called “three-row type SUVs and minivans”. As shown in FIG. 1, a vehicle seat 1 includes a seat body 2 and a slide mechanism 3.

The seat body 2 includes a seat cushion 4 and a seatback 5. The seat cushion 4 is a member configured to support the buttocks of an occupant. The seatback 5 is a member configured to support the back of the occupant.

The seat body 2 is a vehicle seat in which a right seat and a center seat are integrated with each other. Accordingly, the seat cushion 4 is formed by integrating a seat cushion for the right seat and a seat cushion for the center seat. The seatback 5 is formed by integrating a seatback for the right seat and a seatback for the center seat.

The seat cushion 4 includes a cushion frame 4A and a cushion pad (not illustrated). The cushion frame 4A is a member forming the framework of the seat cushion 4. The cushion pad is a cushioning material such as urethane.

The seatback 5 includes a back frame 5A and a back pad (not illustrated). The back frame 5A is a member forming the framework of the seatback 5. The back pad is a cushioning material such as urethane.

The seatback 5 is coupled to the seat cushion 4 via a recliner 6. The recliner 6 couples the seatback 5 to the seat cushion 4 such that the seatback 5 is pivotable relative to the seat cushion 4. The recliner 6 is switchable between a state where the seatback 5 is pivotable and a state where the seatback 5 is non-pivotable.

The recliner 6 is fixed to a recliner plate 4B. The recliner plate 4B is a member that forms a part of a seat frame, such as the cushion frame 4A, and is coupled to a rear end of the cushion frame 4A.

A tilt-forward spring S3, serving as an example of a third spring, is provided at a portion where the seatback 5 and the seat cushion 4 are coupled to each other. The tilt-forward spring S3 is a spring (a spiral spring in the present embodiment) that exerts an elastic force for tilting the seatback 5 forward.

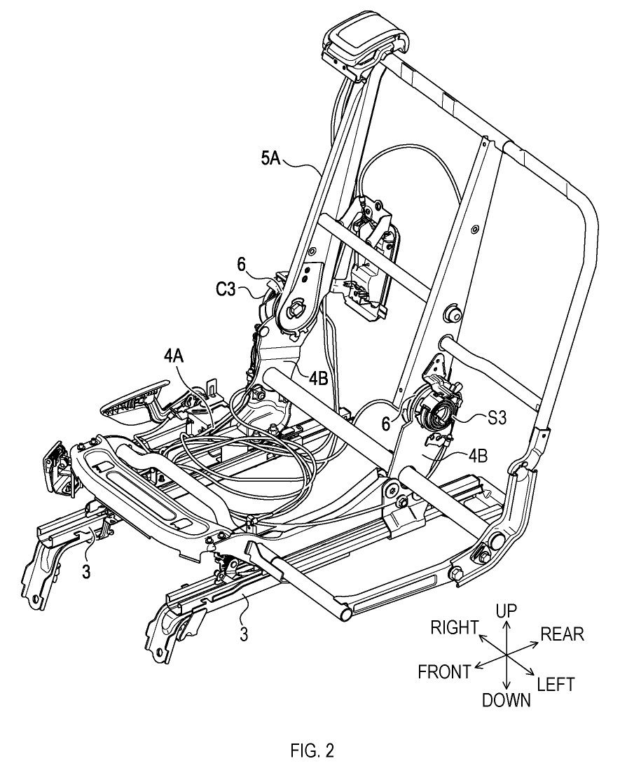

Accordingly, when the seatback 5 is placed in a pivotable state, the seatback 5 tilts forward by the elastic force of the tilt-forward spring S3. Both the recliner 6 and the tilt-forward spring S3 are provided at each of a first end (a right end) of the seat frame in a seat-width direction and a center portion of the seat frame (see FIG. 2).

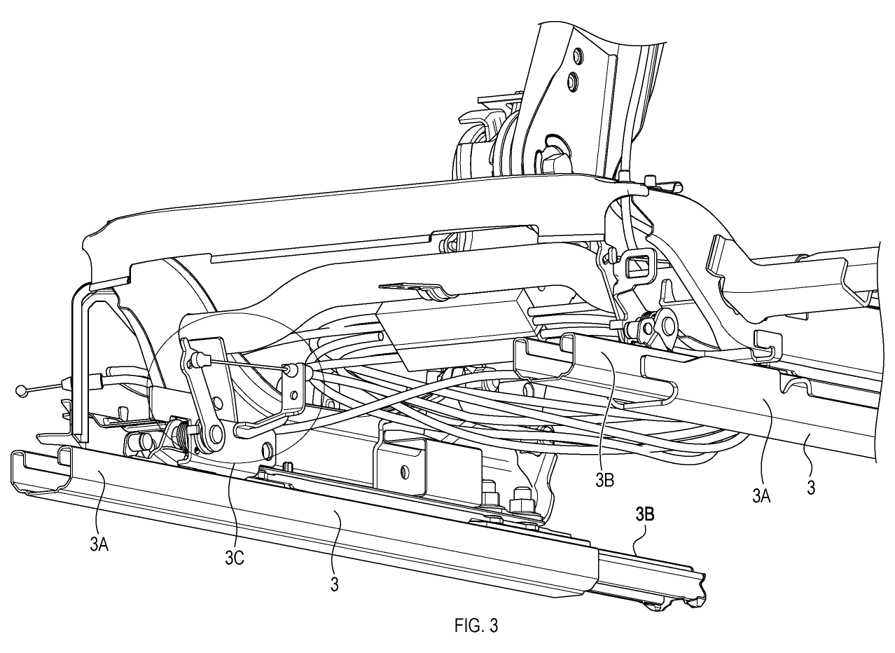

The slide mechanism 3 is a mechanism that slidably supports the seat body 2. As shown in FIG. 3, the slide mechanism 3 includes a fixed rail 3A, a movable rail 3B, and a lock mechanism 3C.

The fixed rail 3A is a guiding member that is directly or indirectly fixed to a vehicle. The movable rail 3B is a movable member that is slidably coupled to the fixed rail 3A. The seat body 2 is fixed to the movable rail 3B.

The lock mechanism 3C is a mechanism configured to switch between a state where the movable rail 3B, and thus the seat body 2, is slidable and a state where the movable rail 3B, and thus the seat body 2, is non-slidable. In the present embodiment, the seat body 2 is supported by two slide mechanisms 3.

The vehicle seat 1 includes a walk-in function. The walk-in function is a function that allows the seat body 2 to slide forward in a state where the seatback 5 is tilted forward only by a predetermined angle (for example, 45 degrees).

Accordingly, as shown in FIG. 1, a walk-in execution mechanism 7 is provided at the first end of the seat frame in the seat-width direction. The walk-in execution mechanism 7 is a mechanism configured to place the lock mechanism 3C in a slidable state in conjunction with an operation of tilting the seatback 5.

The vehicle seat 1 also includes a fold-down function. The fold-down function is a function that allows a back side of the seatback 5 to become substantially horizontal by tilting the seatback 5 significantly forward until the seatback 5 contacts or comes close to the seat cushion 4.

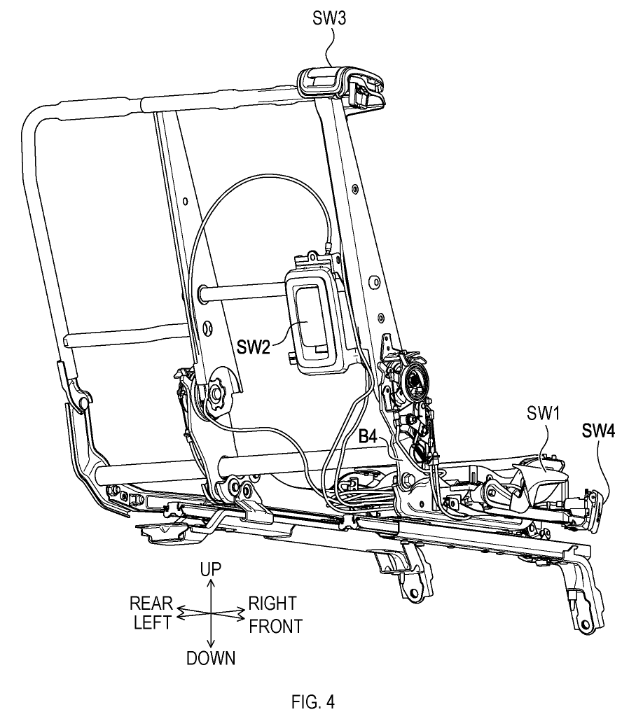

As shown in FIG. 4, walk-in operation levers SW1 and SW2 are provided as operation members for executing the walk-in function. A fold-down operation lever SW3 is provided as an operation member for executing the fold-down function.

These operation levers SW1 to SW3 serve as operation members operated by a user when executing the above-described functions. Specifically, when the walk-in operation lever SW1 or the walk-in operation lever SW2 is pulled, this lever operation is transmitted to each recliner 6 (release lever 6A) via an operation cable. As a result, each recliner 6 is placed in the pivotable state, allowing the seatback 5 to tilt forward due to the elastic force of each tilt-forward spring S3.

When the fold-down operation lever SW3 is pulled, this lever operation is transmitted to each recliner 6 via the operation cable. As a result, each recliner 6 is placed in the pivotable state, allowing the seatback 5 to tilt forward due to the elastic force of each tilt-forward spring S3.

At this time, since a function for restricting the tilting of the seatback 5 is not activated, the seatback 5 continues to tilt until it contacts the seat cushion 4. A slide operation lever SW4 is an operation member operated by the user when releasing the lock mechanism 3C.

### 2. Details of Walk-in Execution Mechanism

### 2.1 Structure of Walk-in Execution Mechanism

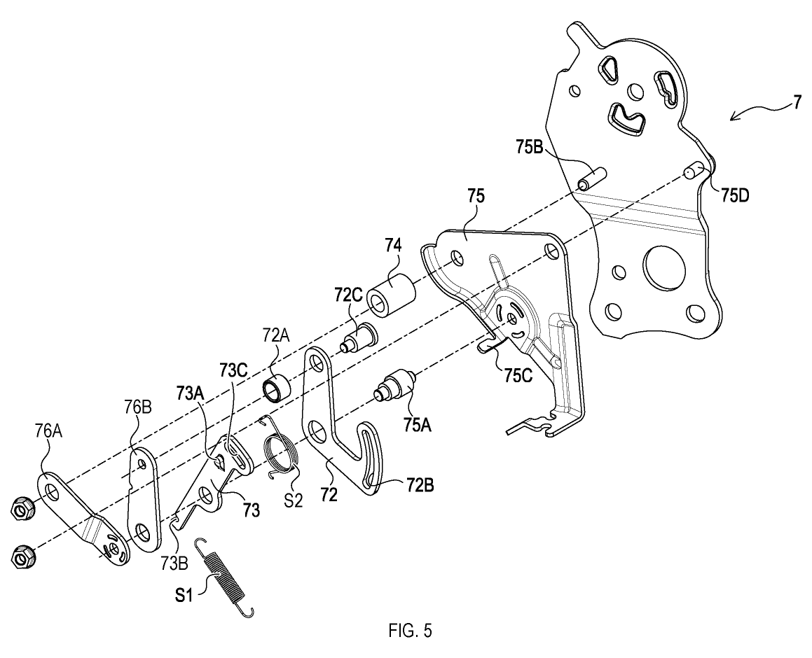

As shown in FIGS. 5-7, the walk-in execution mechanism 7 includes a cam lever 71, a first link lever 72, a second link lever 73, a stopper 74, a base plate 75, a first spring S1, a second spring S2, a first operation cable C1, a second operation cable C2, a third operation cable C3, and a release lever 6A.

### Cam Lever

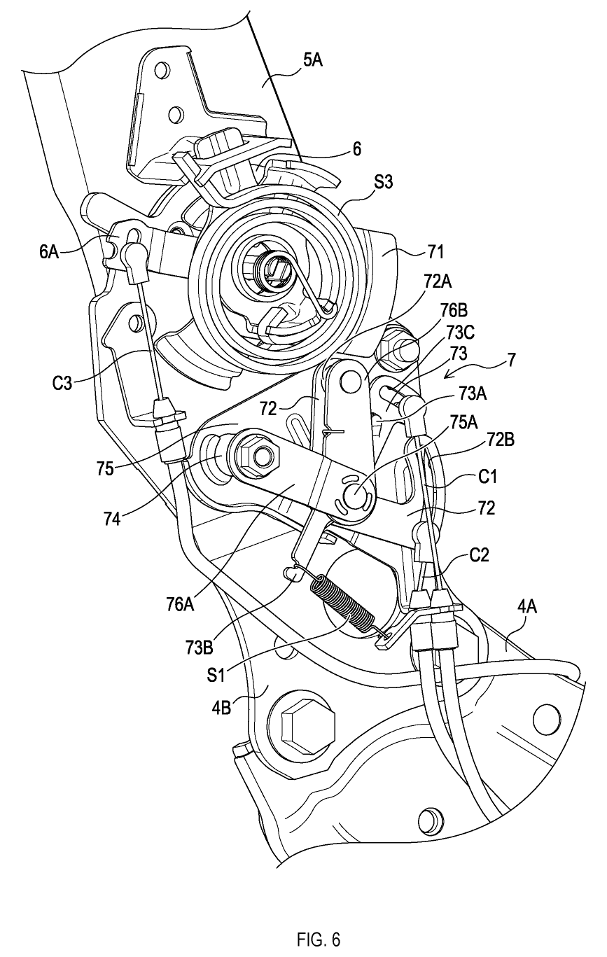

As shown in FIGS. 6-9, the cam lever 71 is a member configured to be rotationally displaced integrally with the seatback 5 about a rotational center axis of the recliner 6.

### First Link Lever

As shown in FIG. 5, the first link lever 72 is rotatably supported by a shaft portion 75A that is fixed to the base plate 75. The base plate 75 is a base of the walk-in execution mechanism 7 and is a member fixed to the recliner plate 4B.

An arc-shaped elongated hole 72B, to which the operation cable is connected, is provided at a first end of the first link lever 72 relative to the rotational center thereof. A contact portion 72A is provided at a second end of the first link lever 72 relative to the rotational center thereof.

The contact portion 72A is formed in a cylindrical shape and is fixed to the first link lever 72 via a second connection plate 76B and a rivet pin 72C. The contact portion 72A is rotatable about the rivet pin 72C. A first end of the rivet pin 72C, serving as an axis, is fixed to the first link lever 72. A second end of the rivet pin 72C is fixed to the second connection plate 76B.

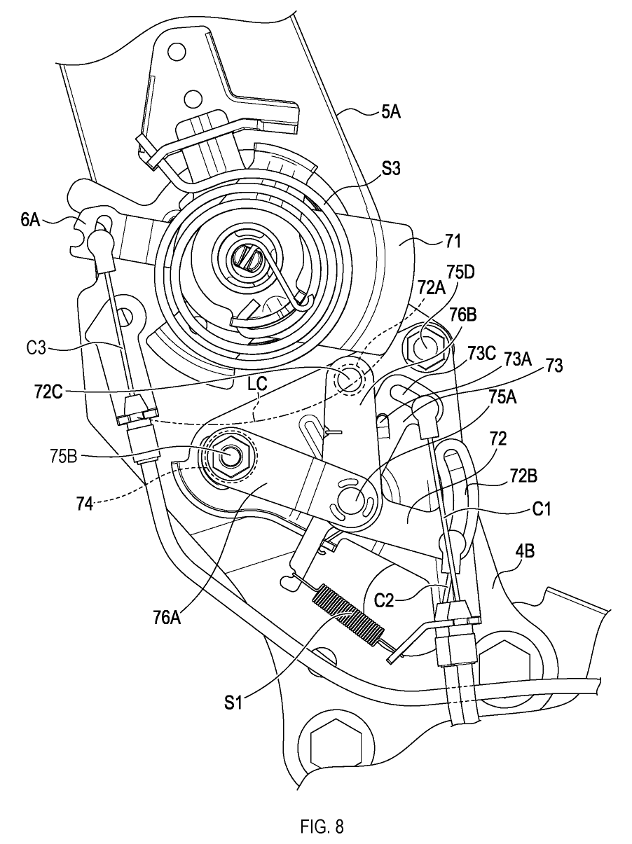

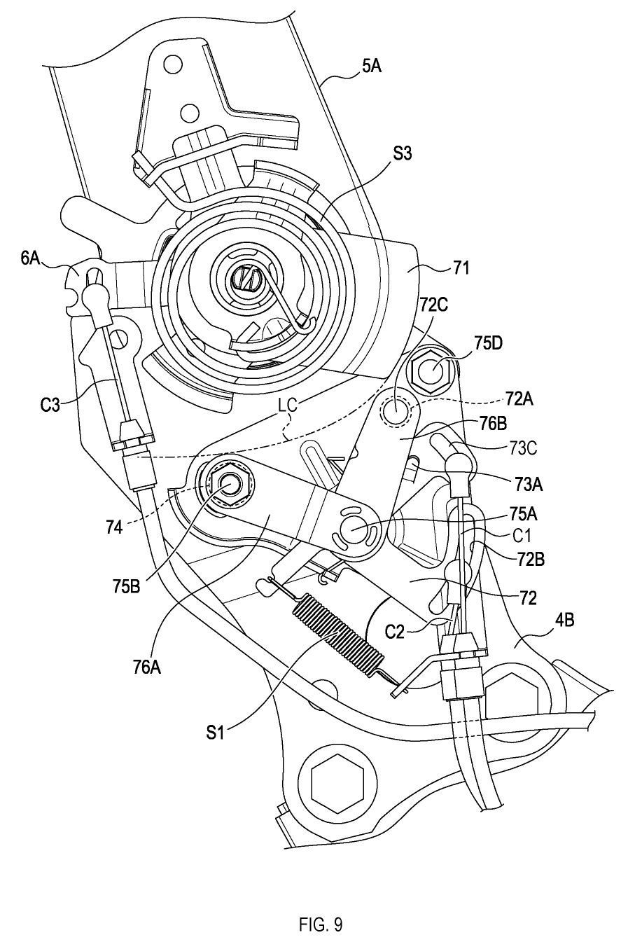

The contact portion 72A is displaced between a first position (see FIG. 8) and a second position (see FIG. 9) in accordance with the rotational displacement of the first link lever 72. The first position is a position at which the contact portion 72A contacts the rotating cam lever 71. The second position is a position at which the contact portion 72A does not contact the cam lever 71 even when the cam lever 71 rotates.

Specifically, as shown in FIGS. 8 and 9, in a case where at least a portion of the contact portion 72A is located on a side of the rotational center of the cam lever 71 with respect to a trajectory LC drawn by a tip of the cam lever 71, the contact portion 72A is in the first position. In a case where the entirety of the contact portion 72A is located on a side opposite to the rotational center of the cam lever 71 with respect to the trajectory LC, the contact portion 72A is in the second position.

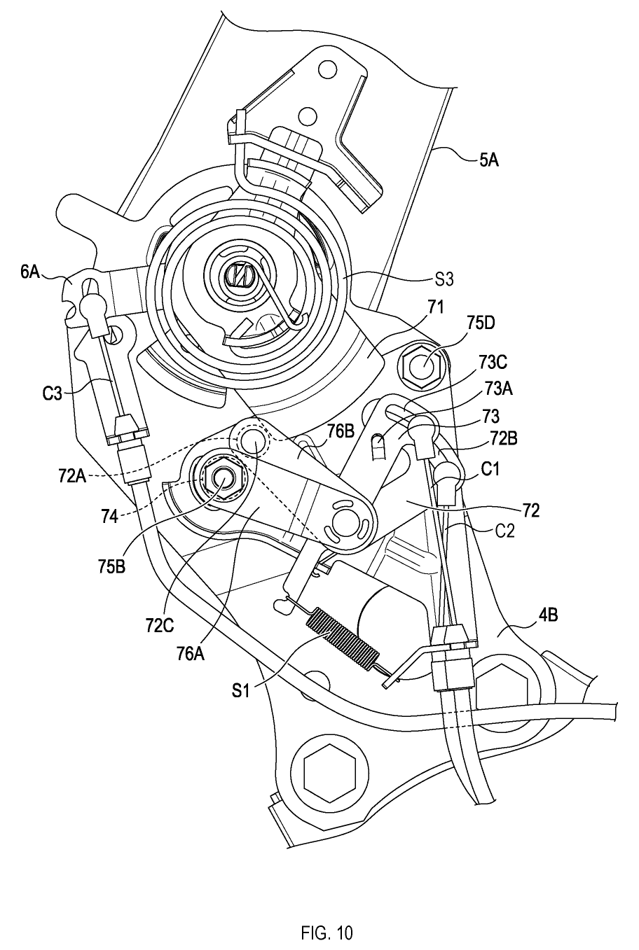

As shown in FIG. 10, in a state where the cam lever 71 and the contact portion 72A are in contact with each other, the first link lever 72 is rotationally displaced by being pressed by the cam lever 71 until the first link lever 72 contacts the stopper 74.

### Stopper

The stopper 74 is a portion that restricts the maximum displacement of the first link lever 72 by contacting the first link lever 72 that is displaced by being pressed by the cam lever 71. The stopper 74 is fixed to the base plate 75 by a joining method such as welding.

Fixing bolts 75B, 75D are bolts for fixing the base plate 75 to the seat frame (to the recliner plate 4B in the present embodiment). The fixing bolt 75D passes through the recliner plate 4B and reaches the base plate 75. The fixing bolt 75B passes through the recliner plate 4B, the base plate 75, and the stopper 74.

An end of the fixing bolt 75B and a first end of the shaft portion 75A are coupled to each other via a first connection plate 76A. The first end of the shaft portion 75A and a first end of the contact portion 72A are coupled to each other via the second connection plate 76B.

### Second Link Lever, First Spring, Second Spring

As shown in FIG. 5, the second link lever 73 is rotatably supported by the shaft portion 75A. The second link lever 73 is rotatable about the same rotational center axis as the first link lever 72.

The second link lever 73 rotates in the same direction together with the first link lever 72 when the first link lever 72 rotates from the first position toward the second position. The second link lever 73 does not rotate in the same direction together with the first link lever 72 when the first link lever 72 rotates by being pressed by the cam lever 71.

Specifically, the first link lever 72 and the second link lever 73 are coupled to each other via the second spring S2. The second spring S2 generates an elastic force (hereinafter referred to as a drawing force) that draws the first link lever 72 toward the second link lever 73.

Accordingly, the first link lever 72 and the second link lever 73 generally rotate integrally with each other. However, when a force that pulls the first link lever 72 and the second link lever 73 away from each other (hereinafter referred to as a separating force) exceeds a predetermined magnitude (hereinafter referred to as a threshold), the second spring S2 is further deformed, and the first link lever 72 and the second link lever 73 begin to separate from each other.

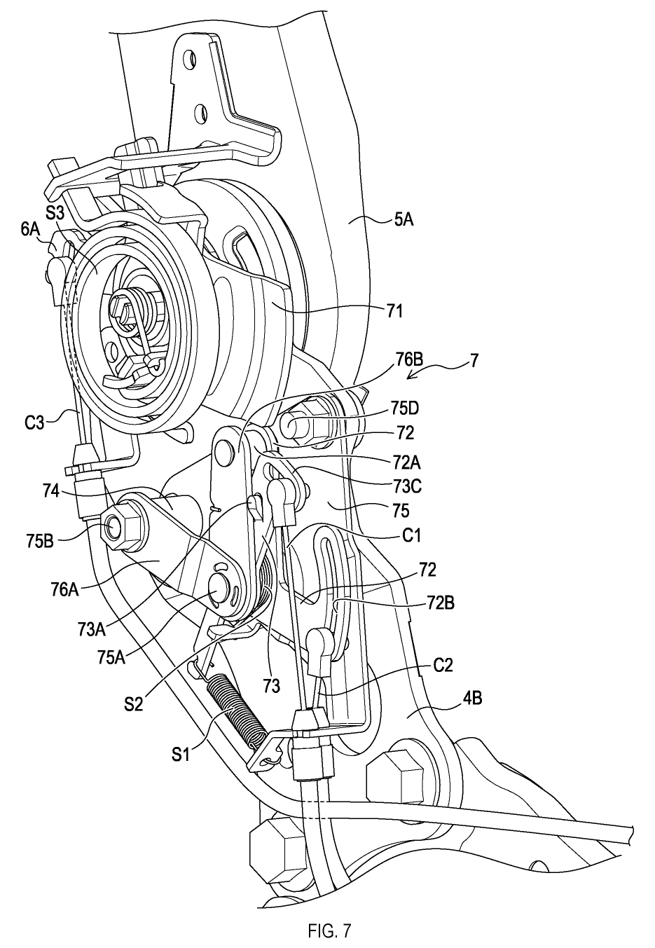

As shown in FIG. 7, the second spring S2 has a second end directly coupled to the base plate 75, and a first end indirectly coupled to the first link lever 72 via the second connection plate 76B.

The second link lever 73 is provided with a stopper 73A. The stopper 73A is a portion with which the second connection plate 76B comes into contact due to the drawing force. Accordingly, when the separating force is less than the threshold, a state in which the stopper 73A and the second connection plate 76B are in contact with each other is maintained.

The second connection plate 76B is integrated with the first link lever 72 as described above. Therefore, in the present embodiment, the second connection plate 76B is a member that forms a part of the first link lever 72.

As shown in FIG. 5, the stopper 73A is disposed on one side of the second link lever 73 with respect to the rotational center thereof. A connection portion 73B to which the first spring S1 is coupled is provided on an opposite side of the second link lever 73 from the stopper 73A across the rotational center of the second link lever 73.

Accordingly, the first spring S1 generates an elastic force that urges the first link lever 72 toward a first position via the stopper 73A. In other words, the first spring S1 generates a force that causes the first link lever 72 to rotate leftward via the stopper 73A (the second link lever 73) (see FIG. 8).

Hereinafter, rotation of the first link lever 72 or the second link lever 73 from the first position toward the second position is referred to as rightward rotation (rotating rightward). Similarly, rotation of the first link lever 72 or the second link lever 73 from the second position toward the first position is referred to as leftward rotation (rotating leftward).

### Operation Cable

The first operation cable C1 is an operation cable configured to be operated when the fold-down function is performed. Specifically, a first end of the first operation cable C1 in an extending direction thereof is directly or indirectly coupled to the fold-down operation lever SW3.

As shown in FIG. 8, a second end of the first operation cable C1 in the extending direction thereof is coupled to the second link lever 73. A connection hole 73C connecting the first operation cable C1 and the second link lever 73 is provided on a side of the second link lever 73 opposite from the connection portion 73B with respect to a rotational center of the second link lever 73.

When the fold-down operation lever SW3 is operated to pull the first operation cable C1, the second link lever 73 rotates rightward (in a direction from the first position toward the second position).

At this time, the first link lever 72 rotates rightward integrally with the second link lever 73 (in a direction from the first position toward the second position). When the fold-down operation lever SW3 is operated, the contact portion 72A is displaced to the second position.

A first end of the third operation cable C3 in an extending direction thereof is directly or indirectly coupled to the fold-down operation lever SW3. Accordingly, when the fold-down operation lever SW3 is operated, the third operation cable C3 is brought into a pulled state in addition to the first operation cable C1.

A second end of the third operation cable C3 in the extending direction thereof is coupled to the release lever 6A of the recliner 6. Accordingly, when the fold-down operation lever SW3 is operated, the recliner 6 is brought into a released state.

The timing at which the recliner 6 is brought into the released state is at or after the time when the second link lever 73 rotates rightward and the contact portion 72A reaches the second position. A connection portion connecting the third operation cable C3 and the fold-down operation lever SW3 or the release lever 6A is configured so as to achieve the aforementioned timing.

A first end of the second operation cable C2 in an extending direction thereof is directly or indirectly coupled to the lock mechanism 3C. A second end of the second operation cable C2 in the extending direction thereof is coupled to the elongated hole 72B of the first link lever 72.

Accordingly, when the first link lever 72 is pressed by the cam lever 71 and rotationally displaced leftward, the second operation cable C2 is operated and pulled by the first link lever 72, so that the slide mechanism 3 is brought into a slidable state.

The first end of the third operation cable C3 in the extending direction thereof is also coupled to the walk-in operation levers SW1 and SW2. Accordingly, when the walk-in operation lever SW1 or SW2 are operated, the third operation cable C3 is brought into the pulled state, so that the recliner 6 is brought into the released state.

### Positional Relationship Between Tilt-forward spring and Walk-in Execution Mechanism

As shown in FIG. 1, the walk-in execution mechanism 7 is disposed only at a first end of the seat frame in the seat-width direction (the right side in the present embodiment). As shown in FIG. 8, the first link lever 72, the second link lever 73, and components provided on the base plate 75 are disposed below the tilt-forward spring S3.

### 2.2 Explanation of Operation of Walk-in Function or Fold-down Function

### Walk-in Function

In a state where the walk-in operation levers SW1 and SW2 are not operated, as shown in FIG. 8, the contact portion 72A is in the first position, and the recliner 6 is in a locked state. In this state, when the walk-in operation lever SW1 or SW2 is operated, the third operation cable C3 is brought into the pulled state, so that the recliner 6 is brought into the released state.

Accordingly, the seatback 5 tilts forward due to an elastic force of the tilt-forward spring S3, so that the contact portion 72A comes into contact with the cam lever 71. Consequently, as shown in FIG. 10, the first link lever 72 is pressed by the cam lever 71 and rotates leftward until the first link lever comes into contact with the stopper 74.

This causes the second operation cable C2 to be pulled by the first link lever 72, thereby bringing the slide mechanism 3 into the slidable state. Thus, the seatback 5 is held in a tilted state at a position where the first link lever 72 and the stopper 74 are in contact with each other, and the slide mechanism 3 is brought into the slidable state. Thereby, the walk-in function is executed in the vehicle seat 1.

### Fold-down Function

In a state shown in FIG. 8 (hereinafter referred to as an initial state), when the fold-down operation lever SW3 is operated and the first operation cable C1 is pulled, the second link lever 73 rotates rightward as shown in FIG. 9. Accordingly, the first link lever 72, that is, the contact portion 72A, reaches the second position.

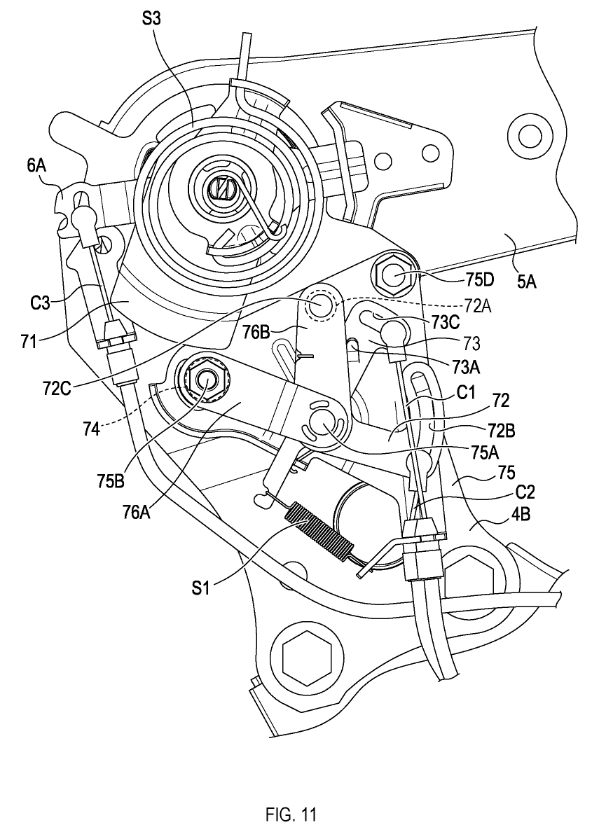

When the contact portion 72A reaches the second position, as described above, the third operation cable C3 is pulled, and the recliner 6 is brought into the released state. Consequently, as shown in FIG. 11, the cam lever 71 is allowed to rotate without the rotational displacement thereof being restricted by the stopper 74.

Therefore, the seatback 5 tilts forward due to the elastic force of the tilt-forward spring S3 and is brought into a fold-down state. In this state, since the fold-down operation lever SW3 is normally not in action, the contact portion 72A returns to the first position by receiving an elastic force of the first spring S1 (see FIG. 11).

In the fold-down state, since the contact portion 72A is in the first position, the cam lever 71 and the contact portion 72A come into contact with each other when the seatback 5 returns from the fold-down state to the initial state.

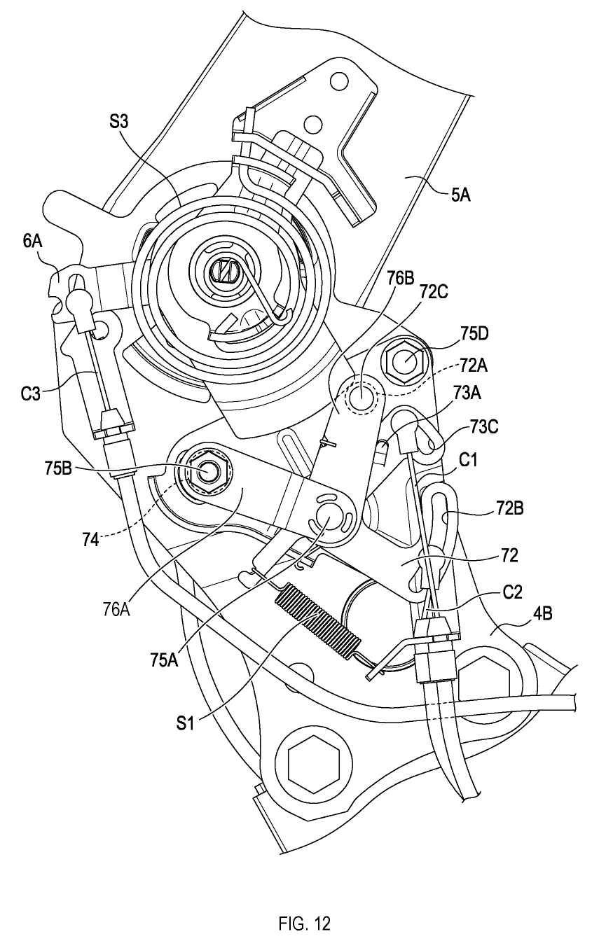

As shown in FIG. 12, the first operation cable C1 is displaceable relative to the connection hole 73C having an elongated shape. Similarly, the second operation cable C2 is displaceable relative to the elongated hole 72B serving as a connection portion.

Accordingly, even when the contact portion 72A is pressed by the cam lever 71 and is displaced from the first position to the second position, an unnecessary force that would cause buckling is not applied to the first operation cable C1 and the second operation cable C2.

### 3. Characteristics of Vehicle Seat

In the vehicle seat 1, as described above, when the recliner 6 is brought into the released state in a state where the first operation cable C1 is not operated, the cam lever 71 and the contact portion 72A come into contact with each other, so that the first link lever 72 is rotationally displaced in response to the rotational displacement of the cam lever 71.

When the first link lever 72 is rotationally displaced, the second operation cable C2 is operated by the first link lever 72, thereby bringing the slide mechanism 3 into the slidable state.

When the recliner 6 is brought into the released state in a state where the first operation cable C1 is not operated, the walk-in function is executed. At this time, the maximum displacement of the first link lever 72 is restricted by the stopper 74, so that the seatback 5 is restricted from tilting forward beyond a predetermined angle.

In the vehicle seat 1, when the recliner 6 is brought into the released state in a state where the first operation cable C1 is operated, the second link lever 73 rotates, so that the first link lever 72 is rotationally displaced from the first position to the second position in conjunction with the rotation of the second link lever 73.

Accordingly, since the cam lever 71 can rotate without coming into contact with the contact portion 72A, the seatback 5 tilts without being restricted by the stopper 74. Therefore, the seatback 5 is allowed to tilt forward beyond the predetermined angle, so that the fold-down function is executed.

In the vehicle seat 1, the first link lever 72 and the second link lever 73 are disposed coaxially. Accordingly, in the vehicle seat 1, the walk-in function and the fold-down function can be achieved with a simpler structure as compared with Patent Document 1.

Furthermore, the vehicle seat 1 includes the second spring S2 that generates an elastic force for drawing the first link lever 72 toward the second link lever 73. Accordingly, when the first operation cable C1 is operated, the first link lever 72 and the second link lever 73 are rotationally displaced integrally with each other, so that the first link lever 72, that is, the contact portion 72A, is rotationally displaced to the second position.

When the cam lever 71 rotates in a state where the cam lever 71 and the contact portion 72A are in contact with each other, the second spring S2 elastically deforms, so that the first link lever 72 can be rotationally displaced until the first link lever 72 comes into contact with the stopper 74.

The stopper 74 of the vehicle seat 1 is fixed to the base plate 75 by welding, and the fixing bolt 75B passes through the base plate 75. Accordingly, in the vehicle seat 1, the stopper 74 can be firmly fixed to the base plate 75.

Preferably, the vehicle seat 1 includes the first connection plate 76A that couples the fixing bolt 75B and the first end of the shaft portion 75A to each other, and the second connection plate 76B that couples the contact portion 72A and the end of the shaft portion 75A to each other.

This allows the shaft portion 75A to be firmly held, and consequently, the occurrence of operational failure in the first link lever 72 and the second link lever 73 in the vehicle seat 1 can be reduced.

As shown in FIG. 6, in the vehicle seat 1, the first link lever 72 and the second link lever 73 are disposed below the tilt-forward spring S3. This allows the tilt-forward spring S3 to be disposed on the same side (the outer side in the present embodiment) as the first link lever 72 and the second link lever 73 relative to the recliner 4B in the vehicle seat 1.

Therefore, in the vehicle seat 1, for example, the size of a portion of the tilt-forward spring S3 protruding inward from the recliner plate 4B is reduced compared to a configuration in which the tilt-forward spring S3 is disposed on the inner side relative to the recliner 4B. Consequently, a likelihood that the occupant feels a sense of discomfort when seated can be reduced.

### Other Embodiments

In the first embodiment, the vehicle seat 1 is configured such that the elastic force of the first spring S1 (the elastic force for bringing the first link lever 72 to the first position) is transmitted to the first link lever 72 via the second spring S2. However, the present disclosure is not limited thereto.

In the first embodiment, the vehicle seat 1 is provided with the first connection plate 76A and the second connection plate 76B. However, the present disclosure is not limited thereto. For example, a configuration in which at least one of the first connection plate 76A or the second connection plate 76B is omitted may be adopted.

In other words, in the first embodiment, the first end of the rivet pin 72C and the second end of the rivet pin 72C are fixed to the first link lever 72 and the second connection plate 76B, respectively. However, the present disclosure is not limited thereto. For example, a configuration in which only the first end of the rivet pin 72C is fixed to the first link lever 72 may be adopted.

In the first embodiment, the tilt-forward spring S3 is disposed on the same side as the first link lever 72 and the second link lever 73 relative to the recliner plate 4B. However, the present disclosure is not limited thereto. For example, a configuration in which the tilt-forward spring S3 is disposed on the inner side relative to the recliner 4B may be adopted.

In the first embodiment, the first operation cable C1 and the third operation cable C3 are configured to be operated via a manual operation lever. However, the present disclosure is not limited thereto. For example, a configuration in which the first operation cable C1 and the third operation cable C3 are operated by an electric actuator of an electric motor may be adopted.

In the first embodiment, the vehicle seat of the present disclosure is applied to a car. However, the application of the invention disclosed herein is not limited thereto. The present disclosure may be applied to a seat used in vehicles such as railroad vehicles, ships and boats, and aircrafts, and also to a stationary seat used in theaters and households, for example.

Furthermore, the present disclosure is only required to coincide with the gist of the disclosure described in the first embodiment and thus should not be limited to the aforementioned embodiments. Therefore, the present disclosure may include a configuration obtained by combining at least two of the aforementioned embodiments, or a configuration obtained by eliminating part of the elements in the drawings or the elements described with reference numerals in the aforementioned embodiment.

What is claimed is:

1. A vehicle seat provided with a walk-in function that enables a seat body including a seatback and a seat cushion to slide forward in a state where the seatback is tilted forward at a predetermined angle, and a fold-down function that tilts the seatback forward beyond the predetermined angle, the vehicle seat comprising:
a slide mechanism configured to slidably support the seat body and configured to be switchable between a slidable state and a non-slidable state;
a recliner configured to be switchable between a released state for allowing rotation of the seatback and a locked state for not allowing rotation of the seatback, the recliner being brought into the released state during execution of the walk-in function and the fold-down function;
a cam lever configured to be rotationally displaced integrally with the seatback about a rotational center axis of the recliner;
a first link lever having a contact portion contactable with the cam lever, the first link lever being configured to be rotationally displaced between a first position where the contact portion contacts the cam lever and a second position where the contact portion is incapable of contacting the cam lever, the first link lever being configured to be pushed by the cam lever to be rotationally displaced in a state where the cam lever and the contact portion are in contact with each other;
a stopper configured to restrict maximum displacement of the first link lever by contacting the first link lever which has been displaced by being pushed by the cam lever;
a spring configured to generate an elastic force to bring the first link lever to the first position;
a second link lever configured to rotate about the rotational center axis common to the first link lever, the second link lever being configured to rotate in a direction identical to a direction of rotation of the first link lever in conjunction with the first link lever when rotating from the first position toward the second position;
a first operation cable configured to be operated when executing the fold-down function and thereby rotating the second link lever from the first position toward the second position; and
a second operation cable configured to be operated by the first link lever that is rotationally displaced by being pushed by the cam lever, the second operation cable being configured to place the slide mechanism in a slidable state.

2. The vehicle seat according to claim 1, further comprising:
a second spring directly or indirectly coupled to the first link lever and the second link lever, the second spring being configured to generate an elastic force that draws the first link lever toward the second link lever.

3. The vehicle seat according to claim 1, further comprising:
a tilt-forward spring having a spiral shape and configured to generate an elastic force for tilting the seatback forward, the tilt-forward spring being disposed on a side of the seat frame where the first link lever and the second link lever are disposed,
wherein the first link lever and the second link lever are disposed below the tilt-forward spring.
